(19) United States
(12) Patent Application Publication
(10) Pub. No.: US 2007/0294135 A1
(43) Pub. Date: Dec. 20, 2007

(54) Consumable Product Sales Methods and Consumable Product Displays

(76) Inventor: N. Henning Zieger, Pasadena, CA (US)

Correspondence Address: HENRICKS SLAVIN AND HOLMES LLP;SUITE 200, 840 APOLLO STREET, EL SEGUNDO, CA, 90245, US

(21) Appl. No.: 11/424,818

(22) Filed: Jun. 16, 2006

(51) Int. Cl. G06Q 30/00

(52) U.S. Cl. 705/26; 705/27

(57) ABSTRACT

Methods and apparatus associated with selling a first product and a second product with advertising at different prices.

### BACKGROUND

The sale of consumable products, e.g. products such as those typically found in grocery and drug stores, can be a difficult, low profit margin business. Many consumers are indifferent to particular brands, as well as to particular retail outlets, and are simply looking for the lowest prices. Such consumers exert considerable pricing pressure on manufacturers and retailers. Other consumers are less cost conscious and are willing to pay more for consumer products which they perceive as being of superior quality. The present inventor has determined that conventional methods and apparatus for simultaneously selling consumable products to both types of consumers at, for example, a physical store or a web site, are less than optimal because they do not allow retailers and manufacturers to address the concerns of particularly price conscious consumers, while maximizing the profitability of sales made to all consumers.

### BRIEF DESCRIPTION OF THE DRAWINGS

Detailed description of exemplary embodiments of the inventions will be made with reference to the accompanying drawings.

FIG. 1 is a flow chart in accordance with one embodiment of a present invention.

FIG. 2 is a flow chart in accordance with one embodiment of a present invention.

FIGS. 3 and 4 are plan views of paper towels in accordance with one embodiment of a present invention.

FIG. 5 is a front view of a display in accordance with one embodiment of a present invention.

FIGS. 6 and 7 are front views of oranges in accordance with one embodiment of a present invention.

FIG. 8 is a front view of a display in accordance with one embodiment of a present invention.

FIG. 9 is a screen shot of a web page in accordance with one embodiment of a present invention.

FIG. 10 is a screen shot of a web page in accordance with one embodiment of a present invention.

FIG. 11 is a screen shot of a web page in accordance with one embodiment of a present invention.

FIGS. 12 and 13 are front views of bottles of shampoo in accordance with one embodiment of a present invention.

FIG. 14 is a front view of a display in accordance with one embodiment of a present invention.

### DETAILED DESCRIPTION

The following is a detailed description of the best presently known modes of carrying out the inventions. This description is not to be taken in a limiting sense, but is made merely for the purpose of illustrating the general principles of the inventions. Additionally, although the present inventions are discussed below in the context of commerce conducted in physical stores and internet sites, the inventions herein also have application in other areas of commerce such as, for example, catalogue sales, vending machines, product advertisement on television, radio and other electronic and non-electronic media, and other areas of commerce yet to be developed.

The methods and apparatus described below relate to the sale of consumable products. As used herein, a “consumable product” is a product that may be consumed or used in such a manner that the amount of the product, based on an applicable unit of measure, will decrease during consumption or use.

Many consumable products may be found in a typical grocery store. By way of example, but not limitation, consumable products include produce such as fresh fruits and vegetables (both prepackaged and loose); canned fruits and vegetables; dairy items such as milk, yogurt, cheese, butter and cream; meats such as beef, poultry and fish (fresh, frozen and canned); beverages such as fruit and vegetable juices, soda, sports drinks, beer, wine, liquor, water, coffee and tea; condiments such as ketchup, mustard, mayonnaise, salad dressing, soy sauce and salsa; pasta and other noodles; snacks such as potato chips, pretzels, candy, crackers, nuts, energy bars and cookies; sauces and marinades; soups; breakfast foods such cereal, oatmeal, pastries, syrup, pancakes and waffles (pre-made and batters); tortillas and various types of bread; sandwich items such as peanut butter, jelly, jam and sandwich meat; baking goods such as sugar, flour, yeast and cake mixes; vegetable oils; baby related products such as baby food, formula, diapers and wipes; frozen foods such as frozen dinners, frozen fruits and vegetables, ice cream, ice pops, and juices; paper goods such as papers towels, napkins, facial and toilet tissue, and paper plates, bowls and cups; storage items such as garbage bags and sealable food bags and containers (e.g. Ziploc® brand bags and containers); pet items such as dog food, cat food and cat litter; cleaning products such as dish soap, laundry soap, surface cleaners, air freshening sprays and devices; and personal hygiene related items such as hand, face and body soap (bar and liquid form), skin lotion, shampoo, conditioner, hair spray, toothpaste, toothbrushes, dental floss, mouth wash, shaving cream, razors, and deodorant.

Other consumable products may be found in a typical drug store. By way of example, but not limitation, consumable products that are available in a typical drug store and not already not listed above include dietary supplements such as vitamin, mineral and protein supplements; first aid related products such as adhesive bandages, and antiseptic and antibiotic ointments and sprays; contact lens care products; non-prescription medications such as cough syrup, aspirin and non-aspirin pain relievers, decongestants, and cold and flu remedies; prescription medications; suntan lotion, sunscreen and lip balm; and cosmetics such as lipstick, mascara, eye liner, foundation, powder, and nail polish.

Still other consumable products might be found is stores that specialize in various areas of commerce. By way of example, but not limitation, consumable products that may be found in an office supply store include pens, pencils, tape, glue, crayons, batteries, pads of paper, and pads of postable notes. Examples of consumable products that may be found in an automotive supply store include shop towels, cleaning solutions, and touch-up paint.

A “consumable product” is not, on the other hand, a product that may purchased and used indefinitely without being substantially consumed. For example, a consumable product is not an automobile, a home entertainment system, a bicycle, a book, a newspaper or a magazine. Nor is a consumable product an analog or digital media storage device such as a video tape, a CD, a DVD or an electronic game cartridge. A consumable product is also not a service, such as cable or satellite television service, internet access, land line or wireless telephone service, audio and video downloading, or on-line gaming.

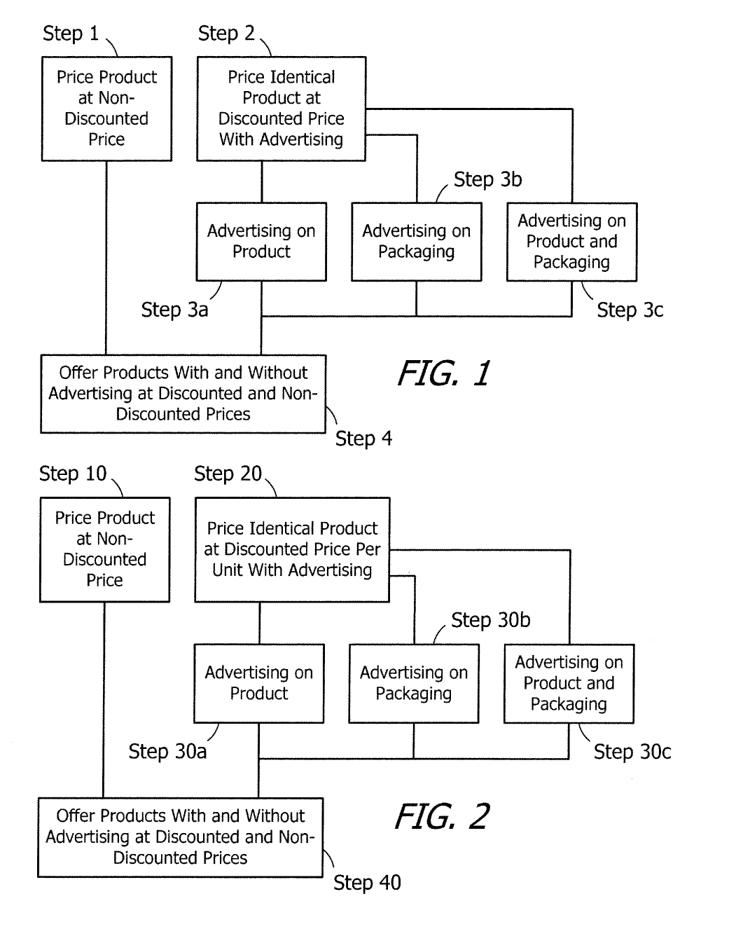

As illustrated for example in FIG. 1, a method in accordance with one embodiment of a present invention involves pricing first and second consumable products, with the second consumable product being priced at a lower price than the first consumable product (Steps 1 and 2). The first and second consumable products are identical in brand, type, amount and quality. However, advertising is included with the second consumable product. The advertising may be included, for example, on the product itself, on the product packaging, or on both the product itself and the product packaging (Steps 3a-3c). The otherwise identical first and second consumable products are then offered for sale at the different prices, i.e. the non-discounted price without advertising and the discounted price with advertising (Step 4).

A product display in accordance with one embodiment of a present invention may include a display device and the first and second products described above in the context of FIG. 1. Examples of such a product display are described below with reference to FIGS. 5 and 8.

Turing to FIG. 2, a method in accordance with one embodiment of a present invention involves pricing first and second consumable products, with the second consumable product being priced at a lower price per unit than the first consumable product (Steps 10 and 20). For example, the overall price of the first and second consumable products may be the same, while the second consumable product is greater in one or more of volume, quantity, weight, watt-hours, servings, etc. The first and second consumable products are identical in brand, type and quality. Advertising is included with the second consumable product. The advertising may be included, for example, on the product itself, on the product packaging, or on both the product itself and the product packaging (Steps 30a-30c). The first and second consumable products are then offered at the two different prices per unit, i.e. the non-discounted price per unit without advertising and the discounted price per unit with advertising (Step 40).

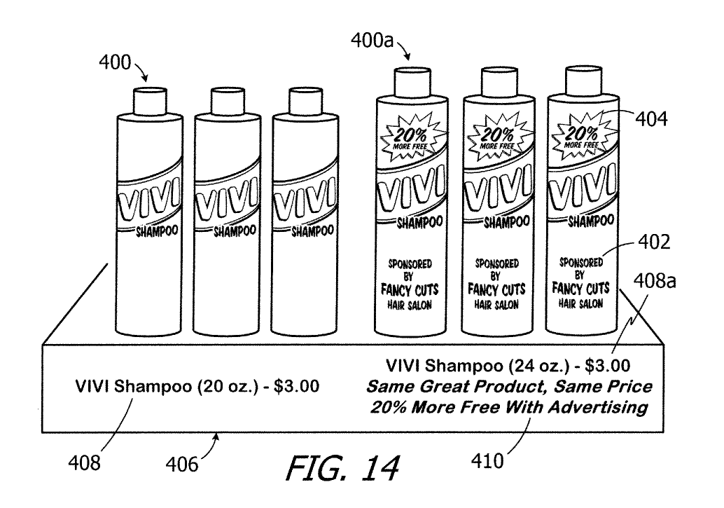

A product display in accordance with one embodiment of a present invention may include a display device and the first and second products described above in the context of FIG. 2. One example of such a product display is described below with reference to FIG. 14.

The methods and apparatus described herein provide a number of advantages over conventional methods and apparatus. For example, the present methods and apparatus allow advertisers to subsidize, through payments to the manufacturer and/or seller, the sale of consumable products. The subsidy may also come from the manufacturer and/or seller in those instances where the manufacturer and/or seller intends to advertise one of its own products or services by advertising on a consumable product. A price conscious consumer who is willing to accept the advertising will purchase the lower priced product (lower total price and/or lower price per unit), while a less price conscious consumer may decide to forgo the advertising and purchase the same product at the higher price (higher total price and/or higher price per unit). In either case, due to the subsidy from the advertiser, the discounting of the price of the second consumable product will not result in the same reduction in profit that would have otherwise been associated with a price reduction. Depending on the price difference and the amount of the subsidy, the net profit on the second consumable product may even be the same as, or greater than, the profit on the first consumable product. The profit associated with sales of the fist consumable product will remain the same because the price is not reduced.

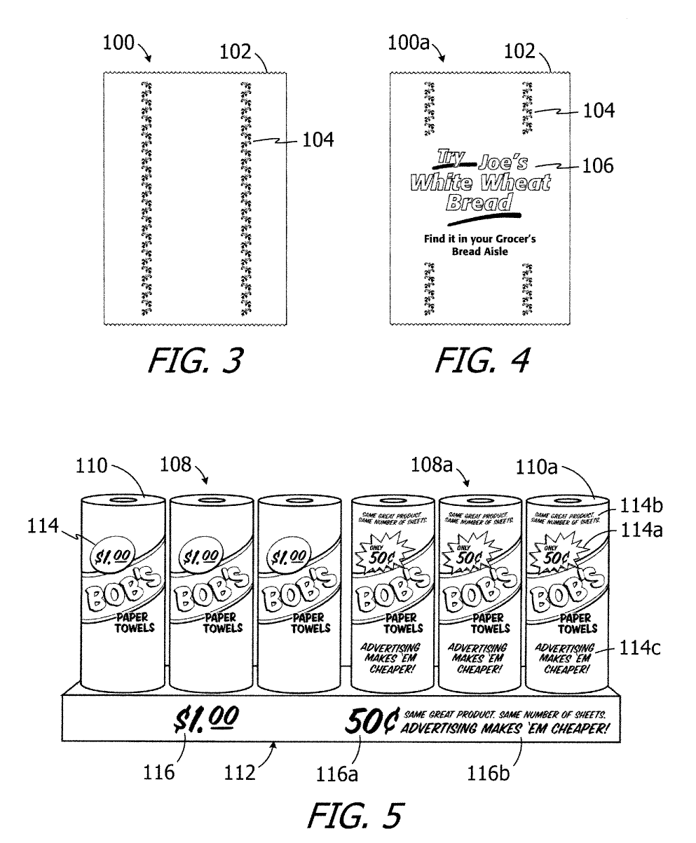

There are, as discussed above, a vast array of consumable products that may be sold in accordance with the methods and apparatus disclosed in the present application. By way of example, but not limitation, paper towels are one example of a consumable product that may be sold in accordance with the present methods and apparatus. Paper towels are also one example of a consumable product that lends itself to advertising on the product itself, as opposed to the product packaging. Turning to FIGS. 3 and 4, first and second paper towels 100 and 100a, which each include a sheet 102 and decorative indicia 104 printed thereon, are identical in brand, type, size and quality. The only physical difference between the first and second paper towels 100 and 100a is that the second paper towel 100a also has an advertising message 106 printed thereon. The advertising message 106 is printed on (or otherwise attached to) the sheet 102 in such a manner that the advertising message will be visible when the paper towel is stored on a paper towel holder and when the paper towel is in use.

The second paper towel 100a will also be sold at a price that is lower than that of first paper towel 100 and the consumer will be made aware of the opportunity to (1) purchase the paper towel 100 without advertising or (2) purchase the otherwise identical paper towel 100a with advertising at a lower price. Paper towels are typically sold in roll form, with a plurality of paper towels rolled around a tube, and in packaging that assumes the shape of the roll. As such, in exemplary display illustrated in FIG. 5, a plurality of the paper towels 100 are provided in each roll 108 and a plurality of the paper towels 100a are provided in each roll 108a. The rolls 108 and 108a, which are enclosed within packaging 110 and 110a, may displayed side by side, or otherwise adjacent to one another, on a store shelf 112, a plurality of store shelves, or some other display device. The packaging 110 and 110a may be provided with certain common aspects such as, for example, a trademark (“Bob's”) and a generic description of the product (“paper towels”). The packaging 110a may also be used to inform the consumer of the opportunity to purchase the paper towels 110a with advertising 106 at lower price than the paper towels 100. In the illustrated example, the packaging 110 includes price indicia 114, while the packaging 110a include price indicia 114a that is indicative of a lower price. The exemplary packaging 110a also includes messages 114b and 114c which respectively indicate that the paper towel roll 108a is otherwise identical to paper towel roll 108 and that the lower price is the result of the advertising. Alternatively, or in addition, the shelf 112 or other display device, and/or signage, may be used to inform the consumer of the opportunity to purchase the paper towels 100a with advertising 106 at lower price than the paper towels 100. In the illustrated example, the shelf 112 includes price indicia 116 for the rolls 108 and price indicia 116a for the lower priced rolls 108a. The shelf 112 also includes a message 116b which indicates that the lower price on otherwise identical products is the result of advertising on the lower priced product.

Although not shown in the illustrated example, the advertising message 106 may also be provided on the packaging 110a itself, even though the packaging will be discarded prior to use of the paper towels 100a. Placing the advertising message 106 on the packaging serves a number of purposes. For example, the advertising message 106 will be visible to all consumers, including those who do not purchase roll 108 or roll 108a. The advertising message 106 will also be visible after purchase, but prior to removal of the packaging 110a from the roll 108a. In addition to such advertising related benefits, making the advertising message 106 visible prior to purchase will allow consumers to view the message prior to purchase, thereby allowing consumers to satisfy themselves that the message is not, in their opinion, somehow objectionable. A consumer with small children, for example, may object to candy related advertising.

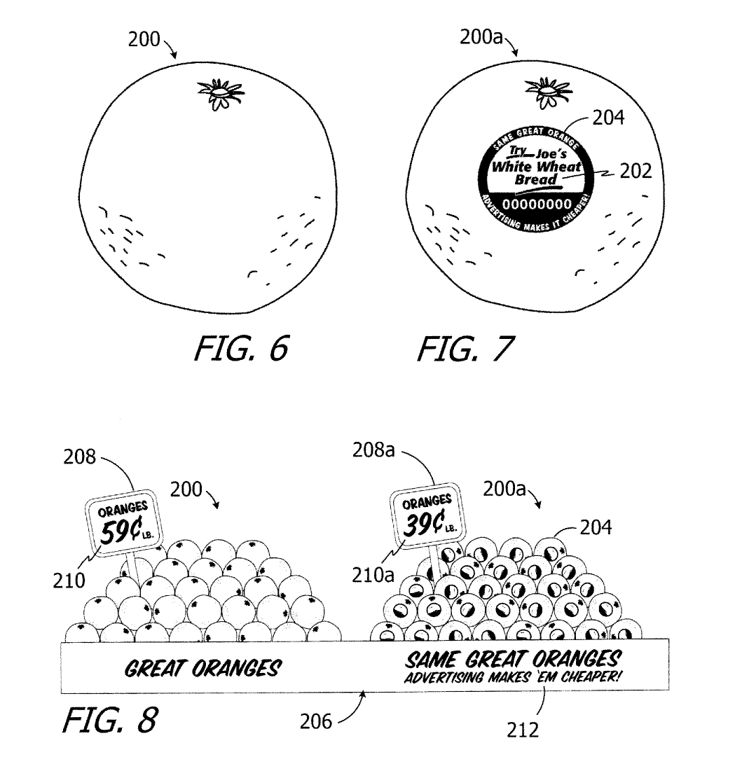

Produce is another exemplary type of a consumable product that may be sold in accordance with the present methods and apparatus. Fresh unpackaged produce is well suited for advertising on the product itself, while fresh packaged produce (e.g. pre-washed, pre-cut lettuce) is well suited for advertising on the packaging. As illustrated for example in FIGS. 6 and 7, first and second oranges 200 and 200a are identical in type and quality. The only physical difference between the first and second oranges 200 and 200a is that the second orange 200a also has an advertising message 202 associated therewith. The advertising message 202 may be printed on a sticker 204 that is attached to orange 200a (as shown), printed directly onto the orange peel, or associated with the orange in some other manner. The second orange 200a will also be sold at a price that is lower than the first orange 200 and the consumer will be made aware of the opportunity to (1) purchase the first orange 200 without advertising or (2) purchase the otherwise identical second orange 200a with advertising at a lower price.

One apparatus for making the customer aware of the aforementioned opportunity is the display illustrated in FIG. 8. Here, the oranges 200 and 200a are displayed side by side on a shelf 206. A first sign 208, with price indicia 210, is associated with the first oranges 200. A second sign 208a, with price indicia 210a that is indicative of a lower price, is associated with oranges 200a. The shelf 206 includes a message 212 which indicates that the lower price on an otherwise identical orange 200a is the result of advertising.

The exemplary display devices in the displays illustrated in FIGS. 5 and 8 are shelves that physically support the products being offered for sale. Other exemplary display devices that physically support, hold, suspend and/or carry products may also be employed. By way of example, but not limitation, hooks, racks, hangers and strip clips are suitable display devices. Other display devices display images, or other representations, of the products being offered for sale instead of the actual products themselves. Examples of such displays include, but are not limited to, monitors (computer, video, etc.), signs, posters, newspaper and magazine pages, and catalogues. It should also be noted here that the present methods and apparatus are not limited to physical (or “brick and mortar”) stores. Consumers may be presented with the same opportunity to purchase otherwise identical products during, for example, electronic commerce type shopping. The shopping may take place by way of, for example, one or more web pages that are displayed on a monitor or other electronic display device.

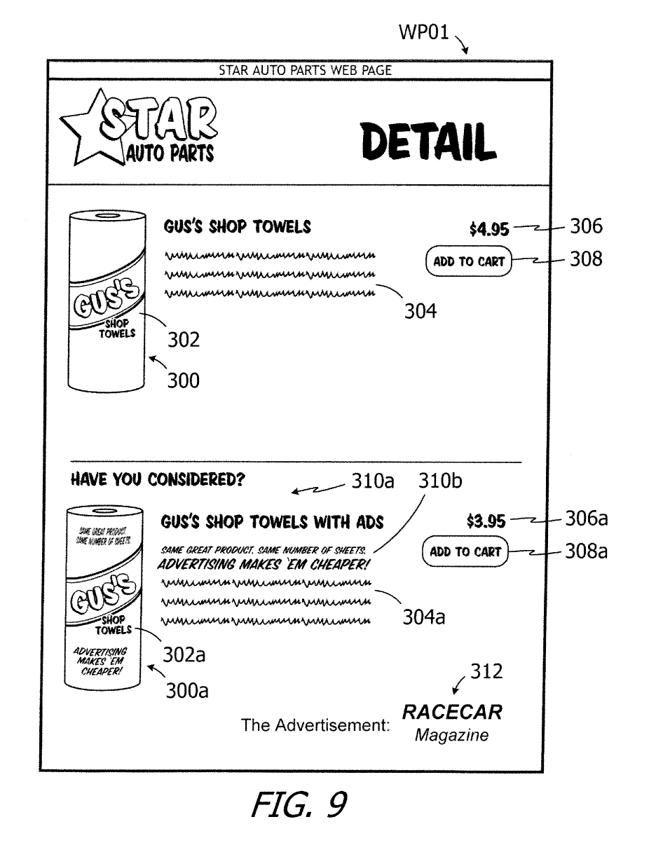

For example, otherwise identical shop towels with and without advertising may be displayed on the exemplary auto parts store web page WP01 illustrated in FIG. 9. Both shop towels may be displayed, either as individual towels (note FIGS. 3 and 4) or as shop towel rolls 300 and 300a in packaging 302 and 302a (as shown in FIG. 9). The rolls 300 and 300a are identical but for advertising on the shop towels in roll 300a. The web page WP01 also includes identical information 304 and 304a about the identical attributes of the shop towels, the respective prices 306 and 306a of the rolls, and “add to cart” buttons 308 and 308a. In addition, the portion of the web page WP01 associated with roll 300a includes messages 310a and 310b inviting the consumer to consider the lower priced roll 300a and advising the consumer that the rolls are identical but for the advertising. The packaging 302a in the illustrated example also includes the “identical roll” information. Accordingly, after the consumer locates shop towels on the exemplary auto parts web site, the consumer will be made aware of the opportunity to (1) purchase the shop towel rolls 300 without advertising or (2) purchase the otherwise identical shop towel rolls 300a with advertising at a lower price. The exemplary web page WP01 may also display the advertising message 312 itself in order to obtain an advertising benefit and facilitate consumer evaluation of the advertising message.

There are, however, a number of other portions of the transaction during which the consumer may be advised of the opportunity to purchase products with advertising at a lower price. The web pages from which the consumer initially selects products may simply display the product (with or without its packaging), any related information, and the price without advertising. Such a page may be similar to the top portion of WP01 illustrated in FIG. 9. The consumer will be made aware of the opportunity to purchase the same products with advertising at a lower price after clicking the associated “add to cart” button, or otherwise indicating an intention to purchase the product. For example, the web site may be designed to display a follow-up page, which may be similar to the bottom portion of WP01 illustrated in FIG. 9, after the consumer initially selects a product for which an advertising based lower price is available.

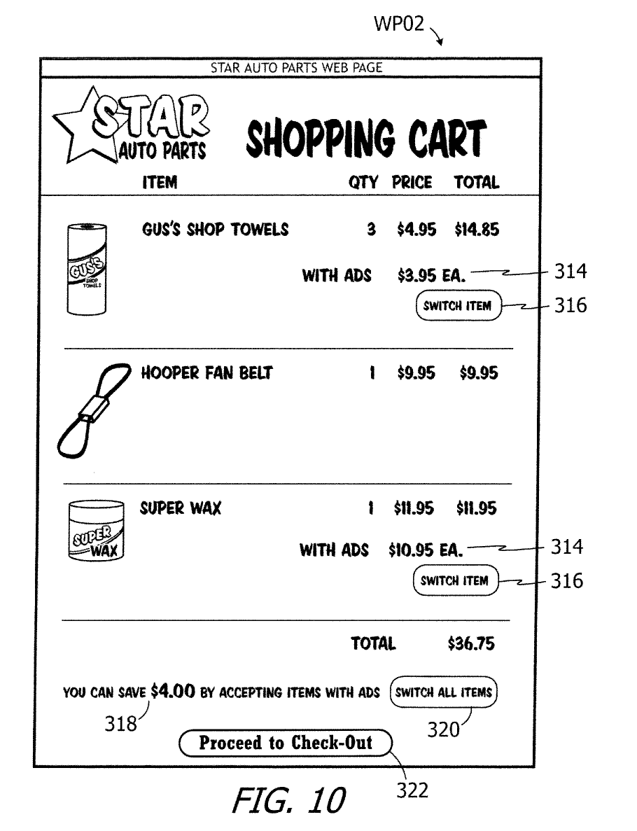

The opportunity to purchase the same products with advertising at a lower price may also be presented in the “shopping cart” page, where the web site lists all of the products that the consumer currently intends to purchase, or another similar page or pages. Referring to FIG. 10, the web page WP02 lists the products that the customer currently intends to purchase as well as information quantity, price and total price information. The exemplary web page WP02 also provides, for those products for which there is an opportunity to purchase the same products with advertising at a lower price, a message 314 which indicates that this opportunity is available and what the lower price is. There is also a button 316 associated with each product, for which the lower price opportunity is available, that allows the consumer to switch from a product without advertising to an otherwise identical product with advertising at a lower price. The exemplary web page WP02 also includes a message 318 which indicates how much money the consumer will save by switching all of the products, for which the lower price opportunity is available, from the versions without advertising to the otherwise identical versions with advertising. A button 320 for switching all of the products is also provided. Should the consumer elect not to take advantage of the lower price opportunity, he or she may simply proceed to the check-out page (not shown) by clicking the “check-out” button 322.

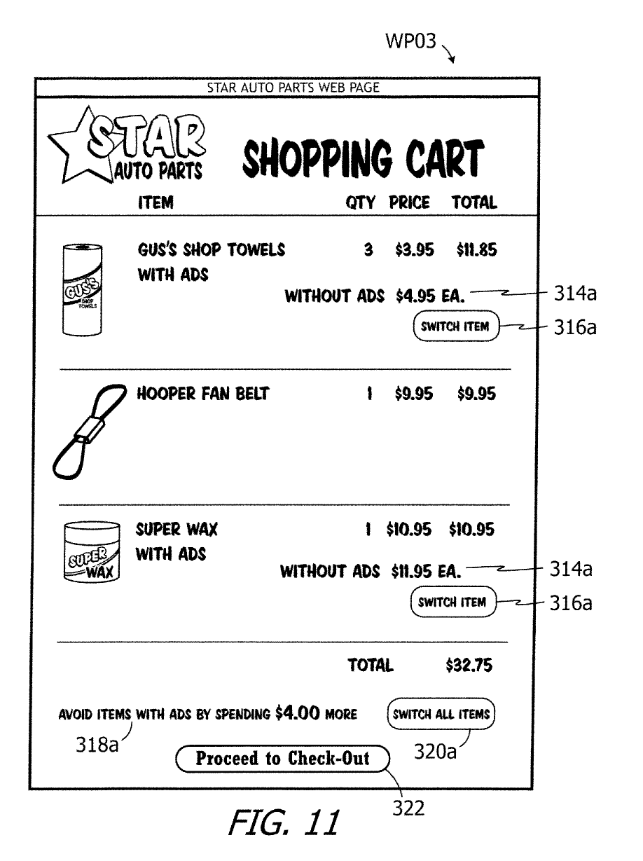

In some implementations, the consumer may also be given the opportunity prior to check-out to switch from one or more of the products with advertising to the otherwise identical, but more expensive, products without advertising. More specifically, after the consumer has chosen one or more products with advertising in, for example, one of the manners described above with reference to FIGS. 9 and 10, the exemplary web page WP03 illustrated in FIG. 11 may be displayed. A message 314a is displayed for those products where there is an opportunity to purchase the same product without advertising at a higher price. Message 314a indicates that this opportunity is available and what the higher price is. There is also a button 316a associated with each product, for which the no advertising opportunity is available, that allows the consumer to switch from the product with advertising to an otherwise identical, but more expensive, product without advertising. The exemplary web page WP03 also includes a message 318a which indicates how much more money the consumer will have to pay if he or she elects to switch all of the products, for which the no advertising opportunity is available, from the versions with advertising to the otherwise identical versions without advertising. A button 320a for switching all of the products is also provided. Should the consumer elect not to take advantage of the no advertising opportunity, he or she may simply proceed to the check-out page (not shown) by clicking on the “check-out” button 322.

As described above with reference to FIG. 2, other methods and apparatus involve selling a product with advertising at a lower price per unit than an otherwise identical product without advertising. “Price per unit” represents an amount of currency (e.g. dollars, euros or yen) for each unit of measure (i.e. volume, quantity, weight, watt-hours, servings, individually packaged servings, etc.) of the product. Frequently, there will be a number of units (e.g. ounces of liquid or number of cookies) in a single package. One dollar per ounce is one example of a “price per unit.” The first and second consumable products are identical in all other physical respects but one. Advertising is included with the second consumable product.

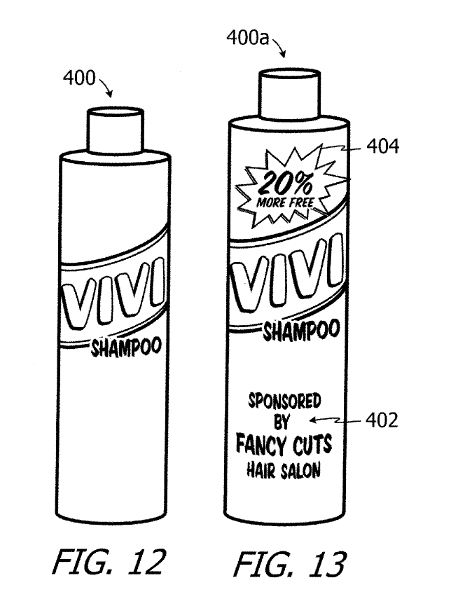

By way of example, but not limitation, shampoo is one example of a consumable product that may be sold in accordance with such methods and apparatus. Shampoo is also one example of a consumable product that lends itself to advertising on the product packaging, as opposed to the product itself. Turning to FIGS. 12 and 13, first and second bottles of shampoo 400 and 400a contain shampoo that is identical in brand, type and quality. The only physical difference between the first and second bottles of shampoo 400 and 400a is that the second bottle 400a also has an advertising message 402. The advertising message 402 may printed on (or otherwise attached to) the bottle of shampoo 400a in such a manner that the advertising message will be visible when the bottle is displayed on a store shelf and stored in the consumer's shower. The second bottle of shampoo 400a will also be sold at a lower price per unit than the first bottle of shampoo 400. More specifically, and although the present methods and apparatus are not so limited, the overall prices (or amounts of currency) of the first and second bottles of shampoo 400 and 400a are the same and the volume of shampoo in the second bottle is greater than the volume of shampoo in the first bottle.

The consumer will be made aware of the opportunity to (1) purchase the bottle of shampoo 400 without advertising or (2) purchase the higher volume, but otherwise identical, bottle of shampoo 400a with advertising at a lower price per unit. To that end, the exemplary bottle of shampoo 400a includes indicia 404 which informs the consumer that there is additional shampoo (e.g. 20% more) in the bottle 400a. There may also be additional indicia on the bottle of shampoo 400a (not shown here) which emphasizes that the shampoo is otherwise identical to the shampoo in bottle 400 and that the lower price is the result of the advertising.

Alternatively, or in addition, the display illustrated in FIG. 14 may be used to make the customer aware of the aforementioned opportunity. Here, the first and second bottles of shampoo 400 and 400a are carried side by side or otherwise adjacent to one another on a shelf 406, a plurality of store shelves or some other display device. In the illustrated example, the shelf 406 includes price and volume indicia 408 for the bottles of shampoo 400 and price and volume indicia 408a for the higher volume bottles of shampoo 400a. The shelf 406 also includes a message 410 which indicates that the increased volume of otherwise identical shampoo is the result of advertising. The same information may be placed on signage associated with the display.

Although the inventions disclosed herein have been described in terms of the preferred embodiments above, numerous modifications and/or additions to the above-described preferred embodiments would be readily apparent to one skilled in the art. By way of example, but not limitation, the color of all or a portion the packaging of otherwise identical first and second products may be differ (e.g. in those instances where the color of the second product packaging is associated with the advertising message). Additionally, the inventions include any combination of the elements from the various species and embodiments disclosed in the specification that are not already described. It is intended that the scope of the present inventions extend to all such modifications and/or additions and that the scope of the present inventions is limited solely by the claims set forth below.

The claims are not to be interpreted as including means-plus- or step-plus-function limitations, unless such a limitation is explicitly recited in a given claim using the phrase(s) “means for” or “step for,” respectively. Additionally, the abstract is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 CFR 1.72(b).

I claim:

1. A method, comprising the steps of:
offering a first consumable product at a first price; and
offering a second consumable product, which is substantially identical to the first consumable product but for the inclusion of advertising with the second consumable product, at a second price that is lower than the first price.

2. A method as claimed in claim 1, wherein the first and second consumable products are located within packaging and the advertising is located on the packaging of the second consumable product.

3. A method as claimed in claim 1, wherein the advertising is located on the second consumable product.

4. A method as claimed in claim 1, wherein the first and second consumable products are located within packaging and the advertising is located on the second consumable product.

5. A method as claimed in claim 1, further comprising the step of:
providing a visible indication that the second consumable product is being offered at a lower price than the first consumable product.

6. A method as claimed in claim 5, wherein the step of providing a visible indication comprises providing a visible indication on the second consumable product that the second consumable product is being offered at a lower price than the first consumable product.

7. A method as claimed in claim 5, wherein the step of providing a visible indication comprises providing a visible indication adjacent to the first and second consumable products that the second consumable product is being offered at a lower price than the first consumable product.

8. A method as claimed in claim 1, further comprising the step of:
displaying the first and second consumable products adjacent to one another.

9. A method as claimed in claim 8, wherein the step of displaying the first and second consumable products comprises displaying the first and second consumable products adjacent to one another on a store shelf.

10. A method as claimed in claim 8, wherein the step of displaying the first and second consumable products comprises displaying the first and second consumable products adjacent to one another on a web page.

11. A method as claimed in claim 1, further comprising the steps of:
displaying the first consumable product on a first web page; and
displaying the second consumable product on a second web page in response to a consumer indication of intent to purchase the first consumable product.

12. A method as claimed in claim 11, providing the consumer with an opportunity to substitute the second consumable product for the first consumable product on the second web page.

13. A method as claimed in claim 1, further comprising the steps of:
displaying the first consumable product on a web page;
alerting the consumer that the second consumable product is available; and
providing a device on the web page that allows the consumer to substitute the second consumable product for the first consumable product.

14. A method, comprising the steps of:
offering a first consumable product at a first price per unit; and
offering a second consumable product, which is substantially identical to the first consumable product but for the inclusion of advertising with the second consumable product, at a second price per unit that is lower than the first price per unit.

15. A method as claimed in claim 14, wherein the first and second consumable products are located within packaging and the advertising is located on the packaging of the second consumable product.

16. A method as claimed in claim 14, wherein the advertising is located on the second consumable product.

17. A method as claimed in claim 14, wherein the first and second consumable products are located within packaging and the advertising is located on the second consumable product.

18. A method as claimed in claim 14, further comprising the step of:
providing a visible indication that the second consumable product is being offered at a lower price per unit than the first consumable product.

19. A method as claimed in claim 18, wherein the step of providing a visible indication comprises providing a visible indication on the second consumable product that the second consumable product is being offered at a lower price per unit than the first consumable product.

20. A method as claimed in claim 18, wherein the step of providing a visible indication comprises providing a visible indication adjacent to the first and second consumable products that the second consumable product is being offered at a lower price per unit than the first consumable product.

21. A method as claimed in claim 14, further comprising the step of:
displaying the first and second consumable products adjacent to one another.

22. A method as claimed in claim 21, wherein the step of displaying the first and second consumable products comprises displaying the first and second consumable products adjacent to one another on a store shelf.

23. A method as claimed in claim 21, wherein the step of displaying the first and second consumable products comprises displaying the first and second consumable products adjacent to one another on a web page.

24. A method as claimed in claim 14, further comprising the steps of:
displaying the first consumable product on a first web page; and
displaying the second consumable product on a second web page in response to a consumer indication of intent to purchase the first consumable product.

25. A method as claimed in claim 24, providing the consumer with an opportunity to substitute the second consumable product for the first consumable product on the second web page.

26. A method as claimed in claim 14, further comprising the steps of:
displaying the first consumable product on a web page;
alerting the consumer that the second consumable product is available; and
providing a device on the web page that allows the consumer to substitute the second consumable product for the first consumable product.

27. A display, comprising:
a display device;
a first consumable product without advertising on the display device and having a first price; and
a second consumable product with advertising included therewith, which is identical to the first consumable product in type and quality, on the display device and having a second price that is lower than the first price.

28. A display as claimed in claim 27, wherein the display device comprises a shelf.

29. A display as claimed in claim 27, wherein the display device comprises a screen.

30. A display as claimed in claim 27, wherein the first and second consumable products are located within packaging and the advertising is located on the packaging of the second consumable product.

31. A display as claimed in claim 27, wherein the advertising is located on the second consumable product.

32. A display as claimed in claim 27, wherein the first and second consumable products are located within packaging and the advertising is located on the second consumable product.

33. A display as claimed in claim 27, wherein the first price comprises a first total price and the second price comprises a second total price.

34. A display as claimed in claim 27, wherein the first price comprises a first price per unit and the second price comprises a second price per unit.
